(19) United States
(12) Patent Application Publication
(10) Pub. No.: US 2021/0291583 A1
(43) Pub. Date: Sep. 23, 2021

(54) Configurable aquatic hardscape sculpture

(71) Applicant: Carib Sea, Inc., Ft. Pierce, FL (US)

(72) Inventors: Richard M. Greenfield, JR., Ft. Pierce, FL (US); Betsey Greenfield Moore, Ft. Pierce, FL (US)

(21) Appl. No.: 17/203,848

(22) Filed: Mar. 17, 2021

Related U.S. Application Data
(60) Provisional application No. 62/990,711, filed on Mar. 17, 2020.

(51) Int. Cl. B44C 5/06; A01K 63/00

(52) U.S. Cl. CPC B44C 5/06; A01K 63/006

(57) ABSTRACT

A configurable aquatic hardscape sculpture comprised of a base having a substantially flat surface on one side to act as a bottom, with receptacle for receipt of a support rod. The support rod allows for the stacking of multiple arch members to personalize a sculpture. In one embodiment the arch members are compressed ventrally with preferably three holes that traverse each member sized for placement on the support rod. The arch members can be faced concave upwards to conform to typical palmate coral growth, or may even be placed concave face-to-face to create a cave or concave downwards to create an arch element to bridge to another structure.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 62/990,711, entitled “CONFIGURABLE AQUATIC HARDSCAPE SCULPTURE” filed Mar. 17, 2020, the contents of which is incorporated herein by reference.

### FIELD OF THE INVENTION

This invention is directed to the field of hobbyist and commercial aquariums; and in particular, to a scalable aquatic reef structure for use in an aquarium.

### BACKGROUND OF THE INVENTION

Tropical reef environments are preferably known to be based on a core of calcium carbonate (limestone and aragonite) rocks, which is the ideal material upon which to grow and display corals in captivity. Nearly all marine and reef aquariums, both hobbyist and commercial, utilize calcium carbonate rocks (both natural and man-made) to provide the aquatic hardscape, as the surface characteristics, chemical composition, and porosity are ideal for aquatic creatures and mimic the natural environment visually. Alternatively the core can made of any suitable non-toxic material.

Known aquatic hardscapes are mostly limited to the placement of individual pieces of rock, natural or artificial (man-made), held in place by gravity, and therefore greatly limiting the scope of what could be achieved artistically. A helical “tree-like” structure is often observed in nature as the preferred growth habit of many different species of living corals. Such coral shapes are also very highly prized for their visually striking appearance. Some advanced aquarists and professionals have endeavored to create sculptures out of natural or man-made rocks, but they are extremely expensive and difficult to replicate. The resulting structures are heavy and invariably weak at the attachment points, and extremely difficult to ship due to size and weight.

Aquarists and professionals may endeavor to assemble a sculpture comprised of natural calcium carbonate rocks (as they are collected naturally or mechanically manipulated to certain shapes) or artificial calcium carbonate rocks. One option has been to purchase dry rock of marine origin, which being of natural occurrence are all different in the manner of shape and size, then permanently glue or cement the different shaped rocks together to form sculptures. This is a very time consuming and expensive process that often fails, forming a weak, unstable creation that is delicate and dangerously heavy for the person lifting it. These large structures can be easily broken when dropped, especially if dropped in the aquarium setting, which can damage the aquarium.

Some commercial aquatic hardscape products include molded plastic pieces which include holes for receipt of pegged artificial sea creatures. These pieces appear artificial and do not allow for customization. Plastic is not considered a good option for aquarists who intend to include living aquatic creatures, such as corals and other sessile invertebrates.

Thus, what is lacking in the industry is a configurable aquatic hardscape sculpture.

### SUMMARY OF THE INVENTION

A configurable aquatic hardscape sculpture comprised of a base having a flat bottom and a rock structure upper surface. A receptacle designed to accept a support rod is formed in the upper surface. The support rod is comprised of a material that is both strong and non-toxic to aquatic animal and plant life. Gently arching artificial elements are about 12 inches in length, the width and geometry may vary, with holes that traverse the piece created to accept common coral plugs, or to accept the support rod in the position desired. Each stackable element preferably forms a gentle concave arch element which can be faced upwards to conform to typical palmate coral growth, or may even be placed face-to-face to create a cave. Alternatively, the concave shaped arch element may be positioned downwards to create a bridge to another structure.

An objective of the invention is to provide the aquarist with a fast, convenient way to form a dramatic, freestanding, strong and stable aquatic hardscape sculpture, made from desirable calcium carbonate material, which can be assembled without the need for cements, glues, putties or any other affixing agent.

Another objective of the invention is to provide a configurable kit for use in displaying and growing corals in a reef aquarium.

Still another objective of the invention is to utilize the vertical space in an aquarium and maximize the exposure to light and water circulation that living corals require to prosper in captivity.

Yet still another objective of this invention is to provide a rapid, safe and easy way to create a freestanding tree-like rock sculpture that resembles a palmate coral reef structure.

Another objective of the invention is to provide a scalable display that can be quickly assembled with each individual element weighing significantly less than the finished structure.

Still another objective of the invention is to provide a structure that can be assembled in one configuration, and then disassembled and reformed into a multitude of different configurations.

An advantage of the instant invention is that it is very useful to virtually any aquarist, retailer, or commercial enterprise who desires a dramatic and customizable aquatic tree-like sculpture that is easily assembled and very stable.

Another advantage is to the saltwater reef aquarist who desires a platform on which to place living sessile invertebrates such as corals. The individual elements can be easily packaged in one or more boxes to make shipping through regular channels less costly. Once the product is in the end-user's home or place of business, it is easily and safely assembled inside the aquarium by installing the individual elements one at a time.

Still another advantage of the instant invention is the scalable nature of the structure, which is beneficial for larger home aquariums, as well as public aquariums and retail display.

Further advantages of the invention include minimizing detritus accumulation, providing more surfaces for corals and light loving invertebrates, creating more open water for fish, allowing increased circulation and sand bed exposure for better filtering efficiency, and eliminating the need for piles of rocks.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

The patent or application contains at least one drawing executed in color. Copies of this patent or patent application publication with color drawings will be provided by the Office upon request and payment of the necessary fee.

FIG. 1A is a perspective view of the hardscape base;

FIG. 1B is a plane view of the support rod;

FIG. 1C is a perspective view of a first arch member;

FIG. 1D is a perspective view of a second arch member;

FIG. 1E is a perspective view of a third arch member;

FIG. 2A is a top view of the hardscape base with attached rod;

FIG. 2B is a top view of a first arch member;

FIG. 2C is a top view of a second arch member;

FIG. 2D is a top view of a third arch member;

FIG. 3A is a top view of the hardscape base and first arch member placed on the support rod;

FIG. 3B is a top view of a second arch member;

FIG. 3C is a top view of a third arch member;

FIG. 4A is a top view of the hardscape base, first and second arch member placed on the support rod;

FIG. 4B is a top view of a third arch member;

FIG. 5 is a top view of the hardscape sculpture with three arch elements attached to the support rod;

FIG. 6 is a front perspective view thereof;

FIG. 7 is a side view of an individual arch element;

FIG. 8 is a bottom view of an individual arch element; and

FIG. 9 is a perspective view of another embodiment of the invention incorporating different size and shaped platforms.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

The instant invention is a configurable aquatic hardscape sculpture comprised of a base with a flat surface to act as a bottom, with a hole drilled or formed in the top surface to accept a support rod. The support rod is comprised of a material that is strong and non-toxic to aquatic animal and plant life. Gently arching artificial elements consist of rock structures that are about 12 inches in length, the width and geometry may vary, with through holes that traverse the elements. The through holes not only accept the most common coral plugs, but also accept the support rod in the position desired. This concave arch element can face upwards to assimilate typical palmate coral growth, placed face-to-face to create a cave, or face downwards to create an arch element or bridge to another structure.

For assembly, the support rod is placed into the receptacle on the base. The individual elements having gently arching shapes with a plurality of holes are placed with one of the holes receiving the vertical support rod, wherein the element is slid down the support rod until seated on the base or the arching element below it. In the preferred embodiment, three to six elements are placed on the rod until the desired effect is achieved.

The structure functions both as a dramatically visual sculpture and an optimum platform for growing corals and other sessile invertebrates. The ventrally compressed surfaces provide platforms, at different depths of water, to place invertebrate species, such as tropical corals, etc., that require light and may have different lighting requirements. The unused holes in the separate arch elements are designed to accept the most coral plugs. Coral plugs are the most widely utilized means to grow and transport small coral colonies from farming facilities to the home aquarium. The coral colonies must typically be removed from the plug and affixed to a growing platform in the aquarium. This is a difficult process and often results in damage to the incipient coral colony. The unused holes on the arch are designed to accept the coral plug without removal of the colony or any fixing agents.

The freestanding and vertical characteristics allow utilization of the entire water column, and allow free circulation of water, which is very important to living corals, and nutrients around and through the sculpture. Utilizing the vertical space in an aquarium also creates an economy of space, in that more horizontal surfaces can be created than if rocks alone are employed as aquatic hardscapes.

The central support rod is set into a special base of a size to accept the designed arch elements. The use of individual arch elements is unique to the industry and allows unskilled consumers a safe and easy way to create a spectacular free standing reef sculpture within seconds.

A calcium carbonate or the like rigid base has a flat bottom side for stability. A receptacle that is essentially perpendicular to the flat side is drilled through the base and designed to receive the support rod. The support rod is of sufficient strength to ensure safety, and of a length to accommodate several arches. Gentle arch elements are comprised of calcium carbonate rock and about 12 inches in length so as to fit in most aquariums. The arches are compressed ventrally (flattened) and may be any width and geometry desired. A minimum of two (2) holes of such a diameter are provided and sized to accept a support rod, one placed in the approximate center of the piece and one placed near the end. The holes are approximately one-half inch in diameter so as to also accept coral plugs.

The base is manufactured by selecting a carbonate rock of about 6 to 18 inches in diameter and cutting it with a rock saw to achieve the flat bottom surface. This sliced rock is then placed on a drill press, flat side on the platform, and a perpendicular receptacle is drilled into the base. This hole is the same diameter as the support rod.

The support rod is made of a material strong enough to safely support the arches without significant bending or mechanical failure; which may be fiberglass, acrylic, PVC or any other strong and non-toxic material. The support rod is sawed to a length that can accommodate several arch pieces. In a preferred embodiment, the support rod is sized to hold three arches. For large tanks, the preferred embodiment is five arches.

Though the arch elements may be manufactured by other methods, the preferred method is by arranging natural rocks over a mold and applying cement so as to fix them in place. As an alternative, natural rocks, pebbles or sand may be used in any combination, then coated in cement and poured or arranged over a mold. It would also be possible to shape natural stone to this shape. Through holes can be formed by inserting plugs into the arch as it is curing, then on the mold, and then removed, or drilled after the piece has finished curing.

The arch elements and base may be painted or coated so as to imitate the encrustations of sea creatures; and the support rod may be similarly coated or painted to make it less conspicuous. The arch elements and base may be infused with water purifying bacteria or cultivated with aquatic creatures prior to retail sale.

The base and arches provide a dramatic, customizable and freestanding aquatic reef structure that can be made literally within seconds without the need for cements, glues, putties or any other binding agents. Comprised of easy-to-handle individual components, the structure can be safely assembled within the aquarium to create a striking and lifelike helical palmate design to display corals to their maximum advantage, or customized to form arches, caves and platforms.

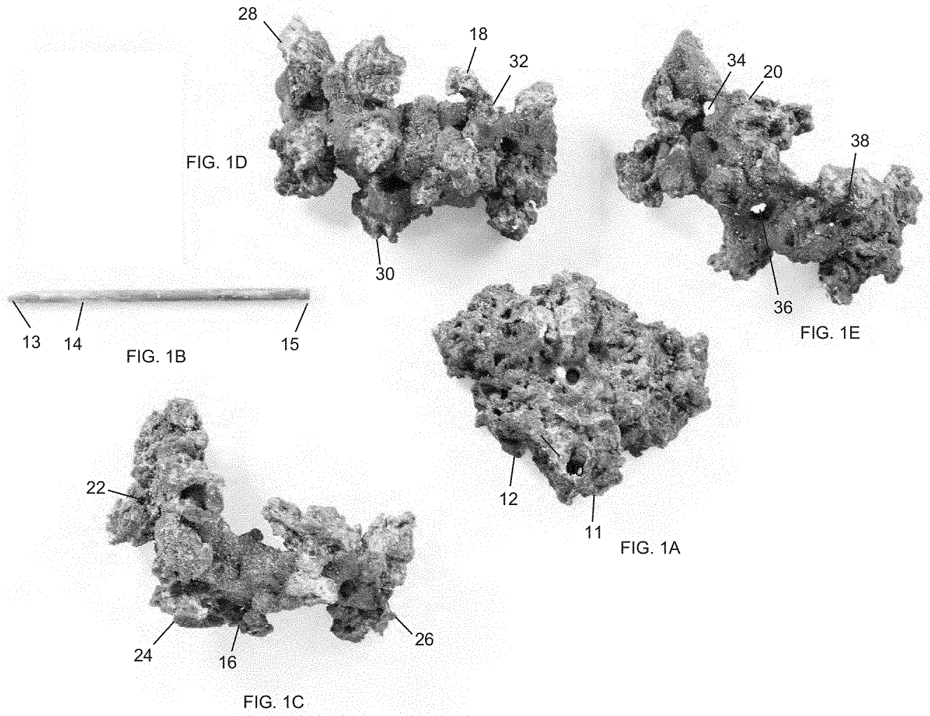

Referring to the drawings in general, and in particular to FIGS. 1A-1E, illustrated are the components of the configurable aquatic hardscape sculpture of the instant invention. The base 10 is constructed of calcium carbonate, basalt, or ceramic through a process that creates a pore structure unique to the particular base. The base 10 has a substantially flat bottom 11 which allows the base 10 to sit flush on the floor of an aquarium. The base 10 has a centrally located receptacle 12 for receipt of a support rod 14 in a position perpendicular to the flat bottom 11.

First arch piece 16 is depicted with three through holes 22, 24 and 26 for selective attachment to the base 10 by slidably placing the arch piece 16 onto the vertical support rod 14. The second arch piece 18 includes three through holes 28, 30 and 32 for by selective attachment to the first arch piece over the base 10 by slidably inserting the arch piece 18 onto the vertical support rod 14, selecting one of the three through holes. An a third arch piece 20 is illustrated also having three through holes 34, 36 and 38 to allow attachment to support rod 14, forming the structure over the base 10 by slidably inserting the arch piece 20 onto the vertical support rod 14. Each arch 16, 18 and 20 is substantially C-shape with the apertures placed around the shape to allow a consumer the ability to select the rock formation based upon placement of arch structure aperture over the support rod 14. While a single aperture allows mounting to the support roc 14, at least two apertures allows the consumer selectively in the shape. Using a centrally placed aperture allows the ends of the arch to face up or down, depending on the consumer preference. Using an end placed aperture allows the end of the arch to be placed in a substantially horizontal position.

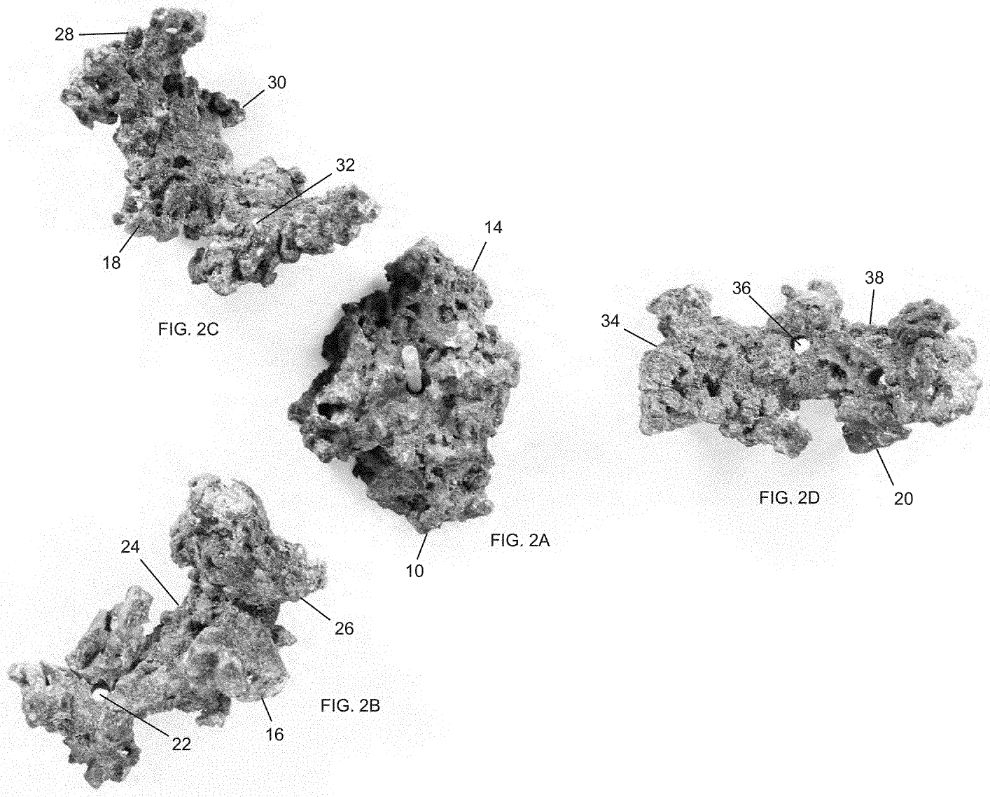

Referring to FIGS. 2A-2D depicted is the vertical support rod 14 slidably inserted into the receptacle 12 of the base 10. The support rod 14 is rigid, having a proximal end 13 that is sized to frictionally engage the receptacle 12, with a distal end 15 extending vertical over the base 10. Arch members 16, 18 and 20 are in position to be attached to the support rod 14.

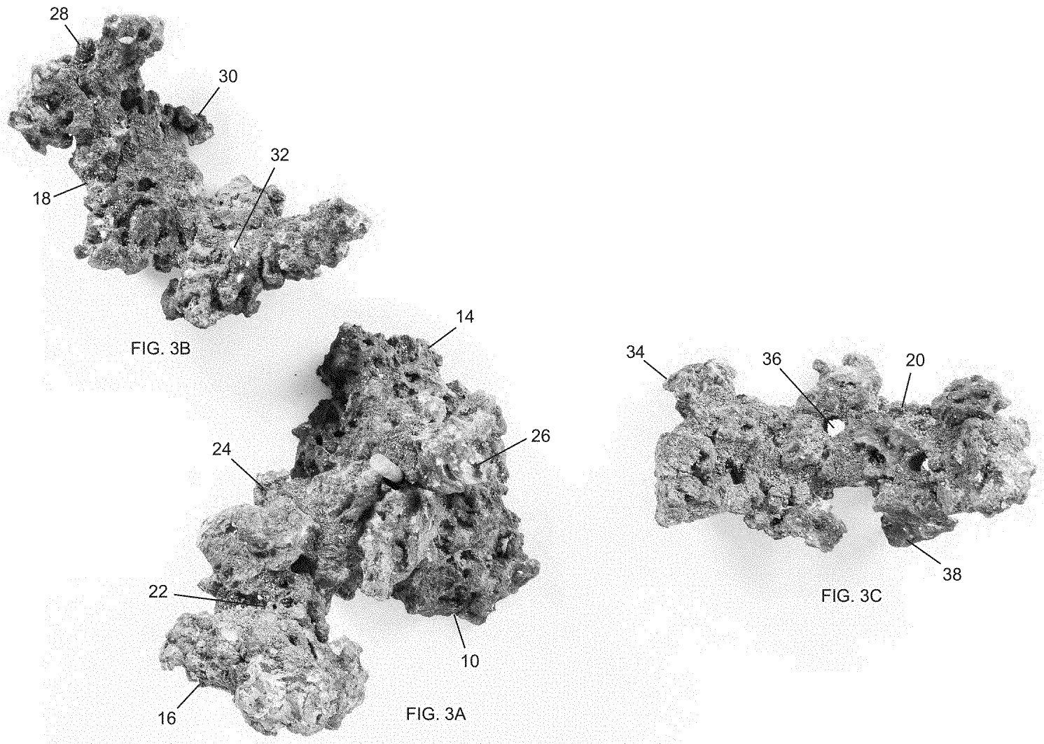

Referring to FIGS. 3A-3C depicted is the first arch piece 16 slidably inserted, using off set through hole 26, onto the vertical support rod 14. In this embodiment, the first arch 16 includes a first offset through hole 22 and a center through hole 26. Selection of which through hole to employ allows the first arch piece 16 to be arranged with either a large fan shape, as shown, a balanced fan shape when the center through hole 24 receives the support rod 14, or an alternate large fan shape when the first offset through hole 22 is utilized. It should also be noted that the first arch piece 16 can be inverted with either of the through holes employed, resulting in downward shaped fans prized for creation of caves. Arch members 18 and 20 are in position to be attached to the support rod 14.

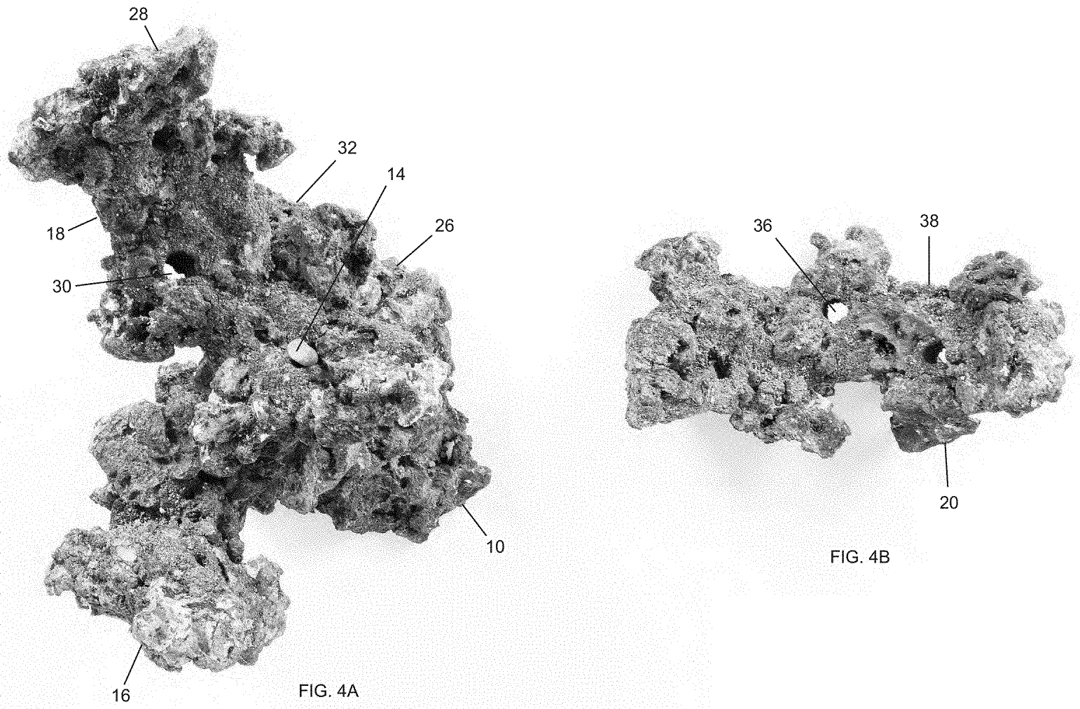

Referring now to FIGS. 4A-4B the second arch piece 18 is slidably inserted onto the support rod 14 using end through hole 32, and placed on top of the first arch piece 16 previously inserted onto vertical support rod 14. Arch member 20 is in position to be attached to the support rod 14.

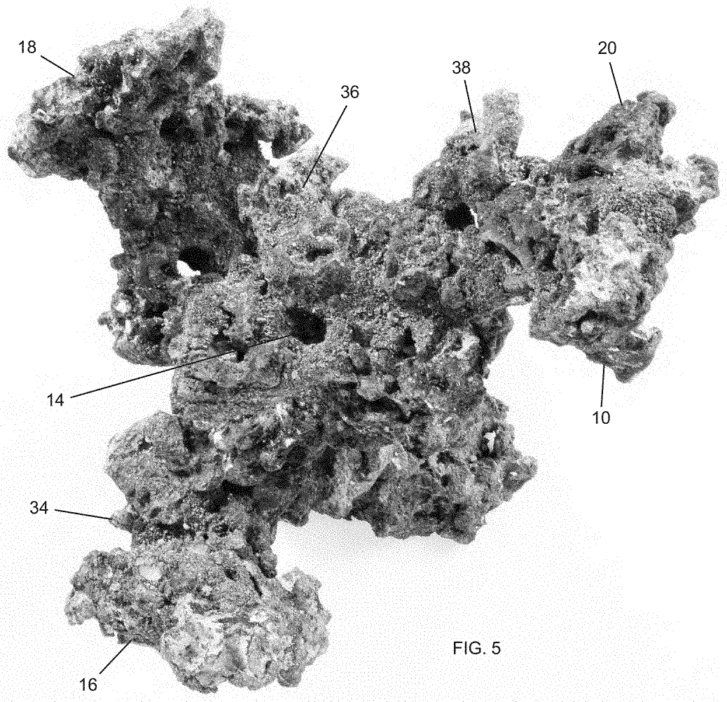

As shown in the top view of FIG. 5, the third arch piece 20 is slidably inserted using center through hole 36, onto the vertical support rod 14 by placement on top of second arch piece 18 and first arch piece 16, both arch pieces previously placed onto vertical support rod 14. The assembly allows the arch pieces to be interchanged, inverted, or otherwise configured in a variety of shapes. For instance, the first arch piece 16 and second arch piece 18 may be placed with the arch open to the top and the third arch 20 inverted.

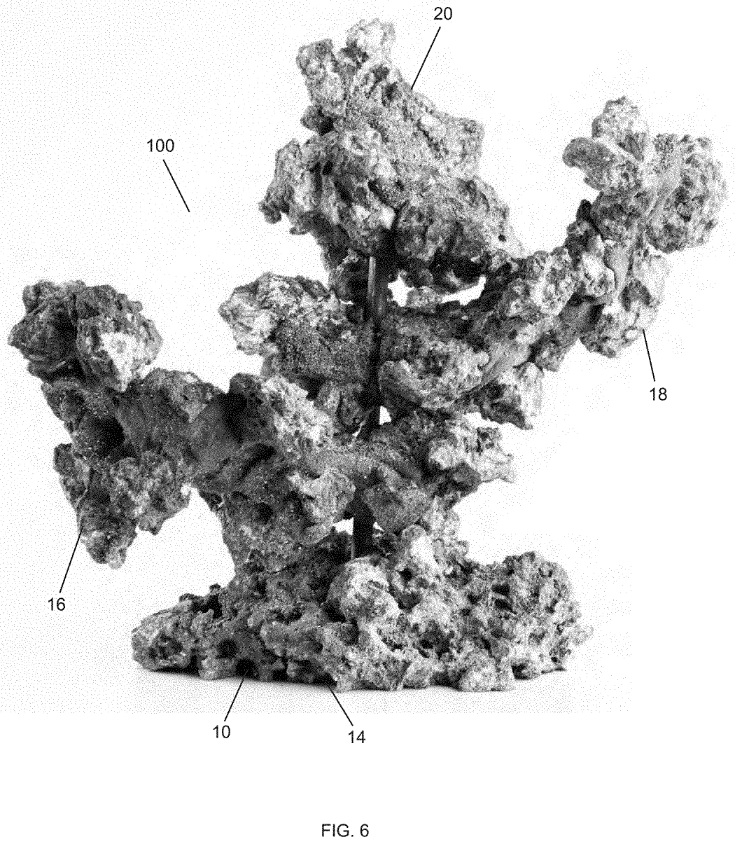

FIG. 6 is a perspective view of the hardscape sculpture 100 in a fully assembled configuration having three arch pieces 16, 18 and 20 slidably inserted onto the support rod 14 and vertically presented over the base 10. While FIG. 6 is illustrative of one configuration, it will be obvious to one skilled in the art that the interchangeability of the arch pieces can alter the shape, but does not alter the invention. It should be further noted that the use of three arch pieces is scalable for use in larger aquariums wherein five or six arch pieces can be used with a longer support rod. In another embodiment, the support rod can be shipped in a longer state, wherein the consumer can cut the rod to a required length.

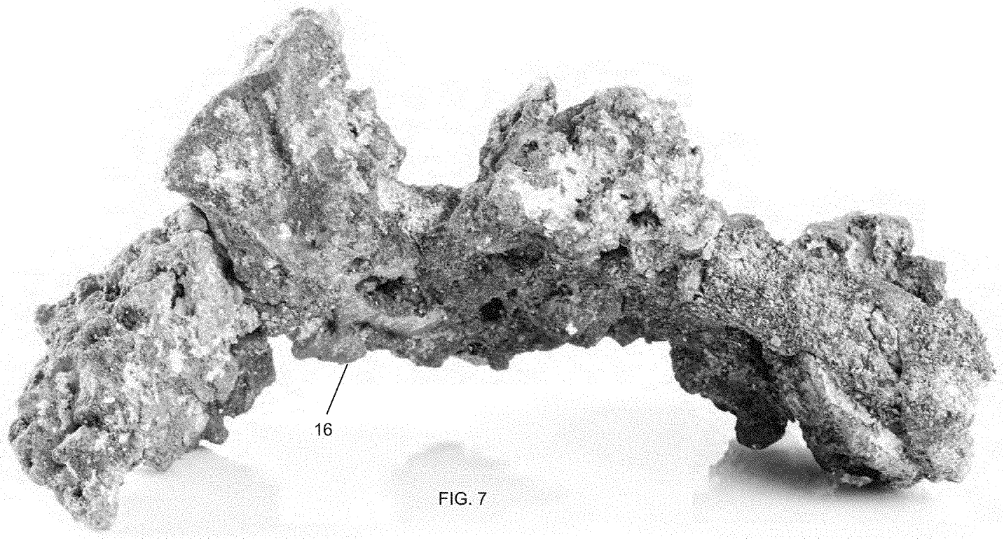

FIG. 7 is a perspective side view of first arch piece 16, which is illustrative of all arch pieces 16, 18 and 20. An arch of about 12 inches in length with preferably three through holes, the size of the arch piece can be scaled up to be longer or scaled down to be shorter. While three through holes is the preferred embodiment, an arch with one hole, two holes, four holes, or even five holes will accomplish the same objective, namely providing a configurable aquatic hardscape sculpture that can be shipped and installed in pieces. By shipping and installing in pieces, the structure can be handled by any size individual, and shipping does not rise above safe lifting amounts. Further, the arch pieces can be wrapped individually to help avoid damage during shipping.

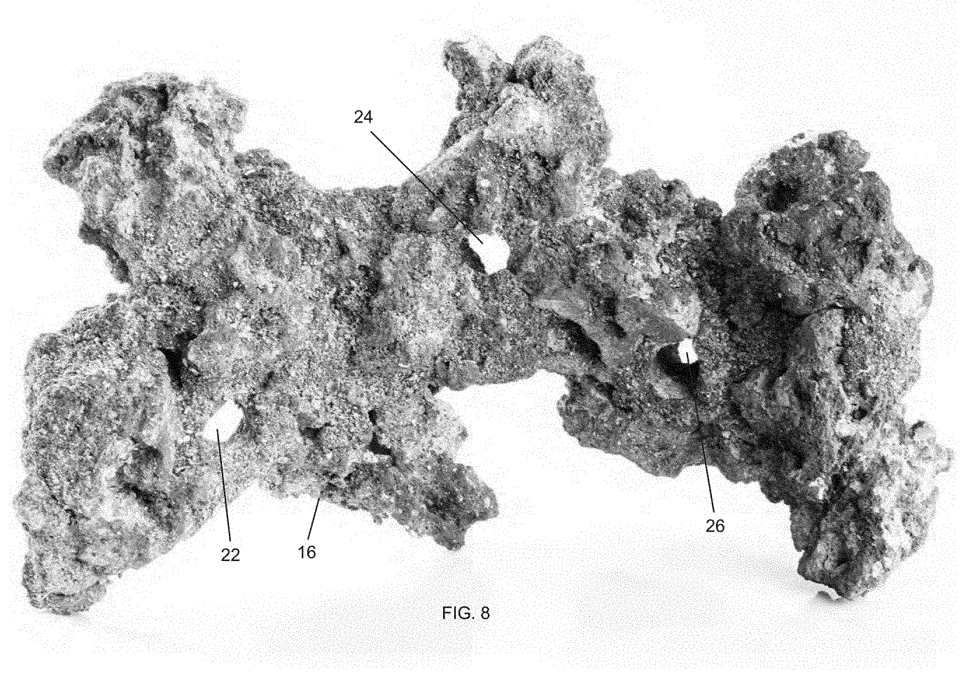

FIG. 8 illustrates a perspective top view of the first arch piece 16 depicting through holes 22, 24 and 26. The through holes used on any of the arches are preferably sized to receive a coral plug. The plug can be ceramic, Delrin, or a farmed coral plug.

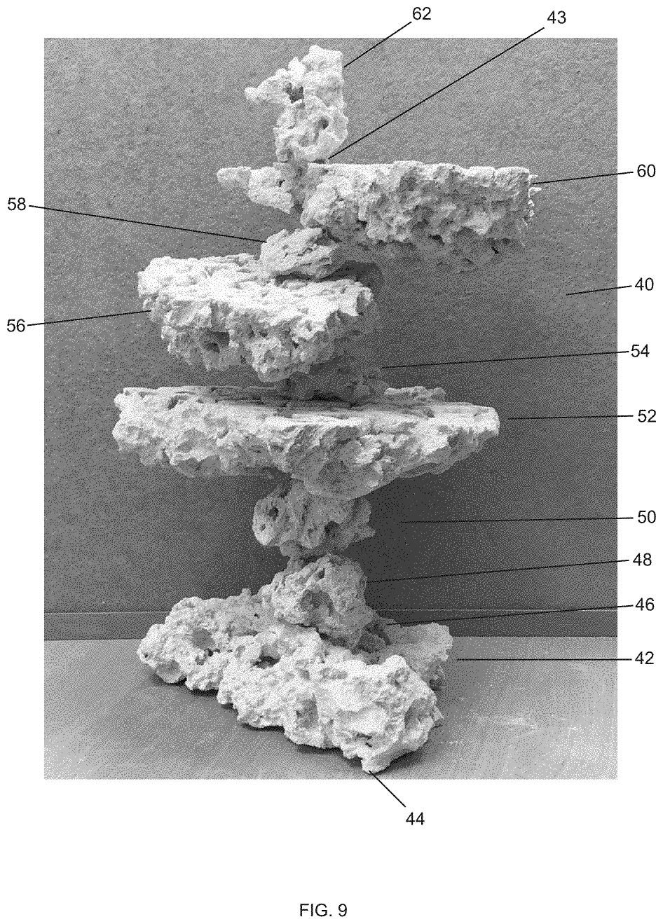

FIG. 9 is a perspective view of another embodiment of the invention incorporating different size and shaped elements. In this embodiment, a configurable aquatic hardscape sculpture 40 consists of a base 42 having a substantially flat bottom 44 with a hardscape top surface 46 having a receptacle centrally positioned in the top surface and formed perpendicular to the flat bottom 44 for placement of the support rod 43. In this embodiment, short elements 48 and 50 are placed over the support rod, followed by a large element 52, small element 54, large element 56, small element 58, large element 60 and small element 62. The various elements can be interchanged and or substituted with arch elements to form a configurable freestanding aquatic reef structure. Similar to the previously described embodiment, the large elements may include multiple through holes, allowing offset or center positioning.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, shapes, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed. The term “about” means, in general, the stated value plus or minus 10%.

1. A configurable aquatic hardscape sculpture comprising:
a base having a substantially flat bottom with a hardscape top surface, a receptacle centrally positioned in said top surface;
a support rod having a proximal end and a distal end, said proximal end slidably insertable into said receptacle;
a first arch element having a first end and a second end defining a length therebetween with at least one through hole extending therethrough, said through hole for receipt of said support rod securing said first arch element to said base;
a second arch element having a first end and a second end defining a length therebetween with at least one through hole extending therethrough, said through holes for receipt of said support rod juxtapositioning said second arch element to said first arch element;
wherein said arch elements are stackable on said base whereby a consumer is able to configure a freestanding aquatic reef structure.

2. The configurable aquatic hardscape sculpture according to claim 1 including a third arch element having a first end and a second end defining a length with at one through hole sized for placement on said support rod.

3. The configurable aquatic hardscape sculpture according to claim 1 wherein said base and each said arch element is constructed from a material selected from the group consisting of calcium carbonate, basalt, or ceramic.

4. The configurable aquatic hardscape sculpture according to claim 1 wherein each said arch element is C-shaped.

5. The configurable aquatic hardscape sculpture according to claim 1, wherein said base is between 6 and 18 inches in diameter.

6. The configurable aquatic hardscape sculpture according to claim 1, wherein each said arch element is about 12 inches in length.

7. The configurable aquatic hardscape sculpture according to claim 1, wherein each said arch element has at least two through holes, each said through hole sized for receipt of said support rod.

8. The configurable aquatic hardscape sculpture according to claim 7 including a plug for filling at least one through hole.

9. The configurable aquatic hardscape sculpture according to claim 1 wherein said receptacle is formed perpendicular to said flat bottom of said base.

10. A configurable aquatic hardscape sculpture comprising:
a base having a substantially flat bottom with a hardscape top surface, a receptacle formed perpendicular to said flat bottom and centrally positioned in said top surface;
a support rod having a proximal end and a distal end, said proximal end slidably insertable into said receptacle;
a first arch element having a first end and a second end defining a length therebetween with at least two through holes extending therethrough, said through hole for receipt of said support rod securing said first arch element to said base;
a second arch element having a first end and a second end defining a length therebetween with at least two through holes extending therethrough, said through holes for receipt of said support rod juxtapositioning said second arch element to said first arch element;
wherein said arch elements are stackable on said base whereby a consumer is able to configure a freestanding aquatic reef structure.

11. The configurable aquatic hardscape sculpture according to claim 10 including a third arch element having a first end and a second end defining a length with at least two through holes sized for placement on said support rod.

12. The configurable aquatic hardscape sculpture according to claim 10 wherein said base and each said arch element is constructed from a material selected from the group consisting of calcium carbonate, basalt, or ceramic.

13. The configurable aquatic hardscape sculpture according to claim 10 wherein each said arch element is C-shaped.

14. The configurable aquatic hardscape sculpture according to claim 10 including a plug for filling at least one through hole.
